(19) United States
(12) Patent Application Publication
(10) Pub. No.: US 2025/0247910 A1
(43) Pub. Date: Jul. 31, 2025

(54) NON-TRANSITORY COMPUTER-READABLE RECORDING MEDIUM STORING COMPUTER-READABLE INSTRUCTIONS FOR TERMINAL DEVICE, TERMINAL DEVICE, AND METHOD FOR CONTROLLING TERMINAL DEVICE

(71) Applicant: BROTHER KOGYO KABUSHIKI KAISHA, Nagoya (JP)

(72) Inventor: Masayuki YATAGAI, Nagoya (JP)

(21) Appl. No.: 19/040,271

(22) Filed: Jan. 29, 2025

(30) Foreign Application Priority Data
Jan. 31, 2024 (JP) 2024-012830

(51) Int. Cl. H04W 76/18; G06F 8/71; H04W 48/02

(52) U.S. Cl. CPC H04W 76/18; G06F 8/71; H04W 48/02

(57) ABSTRACT

The computer-readable instructions, when executed by a processor of a terminal device, may cause the terminal device to provide a first sending instruction to an operating system (OS) program of the terminal device. In a case where related information is received, the computer-readable instructions may cause the terminal device to provide a second sending instruction to the OS program. The related information may be provided according to the OS program in response to a predetermined operation being received. The error screen may be displayed on a display of the terminal device according to the OS program in a case where a predetermined time period has elapsed without a response to the specific signal being received after the first sending instruction has been provided to the OS program. The second sending instruction may be for sending a Probe request including first connection information.

### REFERENCE TO RELATED APPLICATION

This application claims priority to Japanese Patent Application No. 2024-012830 filed on Jan. 31, 2024. The entire content of the priority application is incorporated herein by reference.

### BACKGROUND ART

A communication system including a printer, a terminal device, and a normal AP is known. The terminal device sends a Probe Req. signal including an SSID “YYY” to the printer. At this time, the terminal device does not receive a response signal from the printer. In response to receiving the Probe Req. signal including the SSID “YYY” from the terminal device, the printer activates an alternative SoftAP. After a predetermined time period has elapsed from when the Probe Req. signal was sent, the terminal device sends a Probe Req. signal including the SSID “YYY” to the printer. At this time, the terminal device receives a response signal from the printer and establishes a SoftAP connection with the printer.

### SUMMARY

The disclosure herein provides a novel technology for establishing a wireless connection between a printing device and a terminal device.

The disclosure herein provides a non-transitory computer-readable recording medium storing computer-readable instructions for a terminal device comprising a processor. The computer-readable instructions, when executed by the processor, may cause the terminal device to: provide a first sending instruction to an operating system (OS) program of the terminal device, the first sending instruction being for sending a specific signal to cause a printing device to operate as a parent station of a wireless network; and in a case where related information is received, provide a second sending instruction to the OS program, the related information being provided according to the OS program in response to a predetermined operation for terminating display of an error screen being received, the error screen being displayed on a display of the terminal device according to the OS program in a case where a predetermined time period has elapsed without a response to the specific signal being received after the first sending instruction has been provided to the OS program, the second sending instruction being for sending a Probe request including first connection information for establishing a wireless connection with the printing device.

According to the configuration above, the computer-readable instructions for the terminal device cause the terminal device to provide the first sending instruction to the OS program, and cause the terminal device to provide the second sending instruction to the OS program in the case where the related information is received. In response, a wireless connection is established between the printing device and the terminal device using the first connection information included in the second sending instruction. Thus, a wireless connection can be established between the printing device and the terminal device.

The terminal device implemented by the above computer-readable instructions and a method for controlling the terminal device are also novel and useful. Further, a communication system comprising the terminal device and the printing device is also novel and useful.

### BRIEF DESCRIPTION OF DRAWINGS

FIG. 1 shows a configuration of a communication system.

FIG. 2 shows a sequence diagram for Case A in which the version of OS is a first predetermined version or newer, and a printer is of a Wi-Fi setup-compliant model.

FIG. 3 shows a sequence diagram continued from FIG. 2.

FIG. 4 shows exemplary screens displayed on a terminal device in Case A.

FIG. 5 shows a sequence diagram for Case B in which the version of OS is older than the first predetermined version and the printer is of the Wi-Fi setup-compliant model.

FIG. 6 shows a sequence diagram for Case C in which the version of OS is the first predetermined version or newer and the printer is of a non-Wi-Fi setup-compliant model.

FIG. 7 shows exemplary screens displayed on the terminal device in Case C.

FIG. 8 shows a flowchart of a first setup process executed by an application.

FIG. 9 shows a flowchart of a second setup process executed by the application.

FIG. 10 shows a sequence diagram of a process executed by a terminal device according to a comparative example.

### DESCRIPTION

### Embodiment

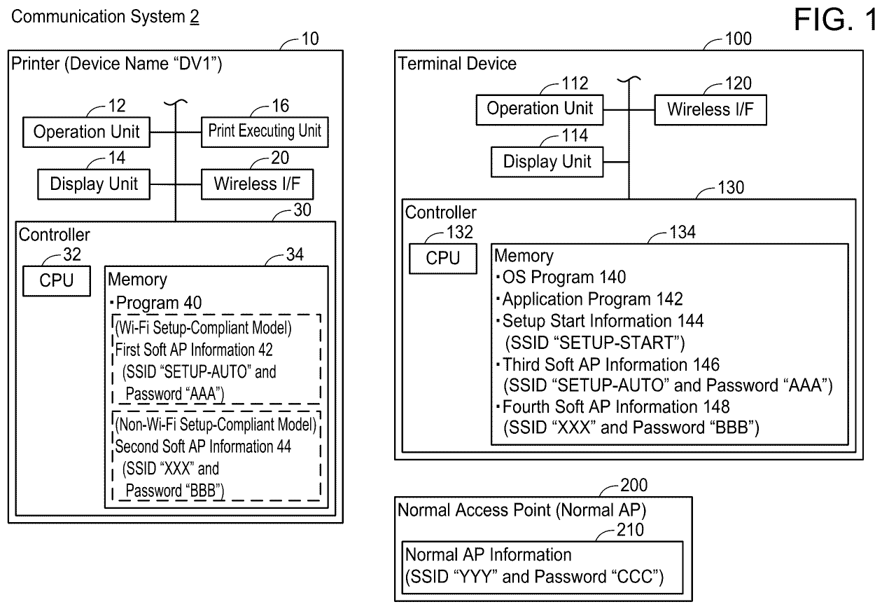

### Configuration of Communication System 2: FIG. 1

As shown in FIG. 1, a communication system 2 comprises a printer 10, a terminal

device 100, and a normal access point 200. Hereinafter, the normal access point 200 is abbreviated as “the normal AP 200”.

### Configuration of Printer 10

The printer 10 is a peripheral device (i.e., a peripheral device of a PC, etc.) configured to execute a print function. The printer 10 has a device name “DV1”. The device name is assigned by the administrator of the printer. The printer 10 is of either a Wi-Fi setup-compliant model or a non-Wi-Fi setup-compliant model. The Wi-Fi setup-compliant model supports a Wi-Fi setup function for establishing a wireless connection between a printer and a normal AP (termed “normal AP connection” hereinafter) without a user's operation to the printer. The non-Wi-Fi setup-compliant model does not support the Wi-Fi setup function. The printer 10 comprises an operation unit 12, a display unit 14, a print executing unit 16, and a wireless interface 20 and a controller 30. Hereinafter, an interface is abbreviated as “I/F”.

The operation unit 12 is an I/F that allows the user to input various information to the printer 10. The operation unit 12 comprises for example a touch screen for displaying software keys (operation objects), hardware keys, or both of these. For example, the hardware keys include buttons, switches, or the like. The display unit 14 is a display or panel for displaying various information. The panel may be or may not be a touch screen. For example, the panel is a liquid crystal panel or an organic EL panel.

The print executing unit 16 includes a print engine of inkjet scheme, electrophotographic scheme, or thermal scheme. A print engine of inkjet scheme comprises a print head configured to discharge ink droplets. A print engine of electrophotographic scheme comprises a photoreceptor and an exposure device configured to emit light to expose the photoreceptor to the light. A print engine of thermal scheme comprises a print head configured to generate heat using a heater.

The wireless I/F 20 is configured for wireless communication according to the IEEE (the Institute of Electrical and Electronics Engineers, Inc.) 802.11. Specifically, the wireless I/F 20 can establish a normal AP connection with the normal AP 200 according to the IEEE 802.11. The printer 10 can join, as a child station, a wireless network in which the normal AP 200 operates as the parent station (termed “normal AP NW (abbreviation for network)” hereinafter). The printer 10 can wirelessly communicate with other devices within the normal AP NW (e.g., the terminal device 100) via the normal AP 200.

The wireless I/F 20 supports especially a SoftAP (abbreviation for software access point) function of the IEEE 802.11. Once a SoftAP of the wireless I/F 20 is activated, the printer 10 operates as the AP (i.e., parent station) of a wireless network and can establish a wireless connection (termed “SoftAP connection” hereinafter) with another device (e.g., the terminal device 100). That is, the other device can join, as a child station, the wireless network in which the printer 10 operates as the parent station (termed “SoftAP NW” hereinafter).

The wireless I/F 20 is physically a single interface. However, a first MAC address used to establish a normal AP connection and a second MAC address used to establish a SoftAP connection are assigned to the wireless I/F 20. The first MAC address is different from the second MAC address. Thus, the printer 10 can wirelessly communicate through a normal AP connection and wirelessly communicate through a SoftAP connection at the same time. In a modification, an I/F configured for wireless communication through a normal AP connection and an I/F configured for wireless communication through a SoftAP connection may be configured as physically different chips.

The controller 30 comprises a CPU 32 and a memory 34. The memory 34 comprises a main storage and an auxiliary storage. In an example, the main storage comprises a RAM and a cache memory. In an example, the auxiliary storage may be a ROM, a flash memory, a solid state drive (SSD), a hard disk drive (HDD), or a combination thereof. A program 40 is stored in the auxiliary storage of the memory 34. The CPU 32 executes various processes according to programs loaded from the auxiliary storage to the main storage.

In the case where the printer 10 is of the Wi-Fi setup-compliant model, first SoftAP information 42 is further stored in the memory 34. The first SoftAP information 42 is used in a first SoftAP NW formed by a first SoftAP. The first SoftAP is activated in response to receiving a signal corresponding to the Wi-Fi setup function from the terminal device 100. The first SoftAP information 42 is determined in advance by the vendor of the printer 10. The first SoftAP information 42 includes an SSID “SETUP-AUTO”, a password “AAA”, etc. “SSID” is an abbreviation of service set identifier.

In the case where the printer 10 is of the non-Wi-Fi setup-compliant model, second SoftAP information 44 is further stored in the memory 34. The second SoftAP information 44 is used in a second SoftAP NW formed by a second SoftAP. The second SoftAP is activated in response to an operation being performed on a Wi-Fi button of the operation unit 12 of the printer 10. The second SoftAP information 44 is determined in advance by the vendor of the printer 10. The second SoftAP information 44 is different from the first SoftAP information 42. The second SoftAP information 44 includes an SSID “XXX”, a password “BBB”, etc.

### Configuration of Terminal Device 100

The terminal device 100 is a terminal device such as a mobile phone (e.g., a smartphone), a PDA, a tablet PC, or the like. The terminal device 100 comprises an operation unit 112, a display unit 114, a wireless I/F 120, and a controller 130.

The operation unit 112 is an I/F that allows the user to input various information to the terminal device 100. The operation unit 112 comprises for example a touch screen for displaying software keys (operation objects), hardware keys, or both of these. For example, the hardware keys include buttons, switches, or the like. The display unit 114 is a display or panel for displaying various information. The panel may be or may not be a touch screen. For example, the panel is a liquid crystal panel or an organic EL panel. The wireless I/F 120 has the same configuration as that of the wireless I/F 20 of the printer 10.

The controller 130 comprises a CPU 132 and a memory 134. The memory 134 comprises a main storage and an auxiliary storage. An OS program 140 and an application program 142 are stored in the auxiliary storage of the memory 134. OS is an abbreviation of operating system. Hereinafter, the OS program 140 and the application program 142 are termed “OS 140” and “app 142”, respectively. The OS 140 controls basic operations of the terminal device 100. For example, the OS 140 is iOS (registered trademark), Android (registered trademark), or the like. The app 142 is a program for establishing a normal AP connection between a printer and the normal AP 200. Hereinafter, various processes the CPU 132 executes according to the programs may be described as if the OS 140 or the app 142 executes these processes. Setup start informant 144, third SoftAP information 146, and fourth SoftAP information 148 are further stored in the auxiliary storage of the memory 134. The setup start information 144 is for activating a first SoftAP of a printer for which a normal AP connection is to be established with the normal AP 200. The third SoftAP information 146 is the same as the first SoftAP information 42. The fourth SoftAP information 148 is the same as the second SoftAP information 44 in the printer 10.

### Configuration of Normal AP 200

The normal AP 200 is a generally known AP, which is called a wireless AP, a wireless LAN router, or the like, and is different from a SoftAP. The normal AP 200 relays communication between a pair of devices which have already established normal AP connections with the normal AP 200. The pair of devices is a pair of child stations (e.g., the printer 10 and the terminal device 100) within the normal AP NW. The normal AP 200 stores normal AP information 210 currently used in the normal AP NW. The normal AP information 210 includes an SSID “YYY” and a password “CCC”.

### Specific Cases

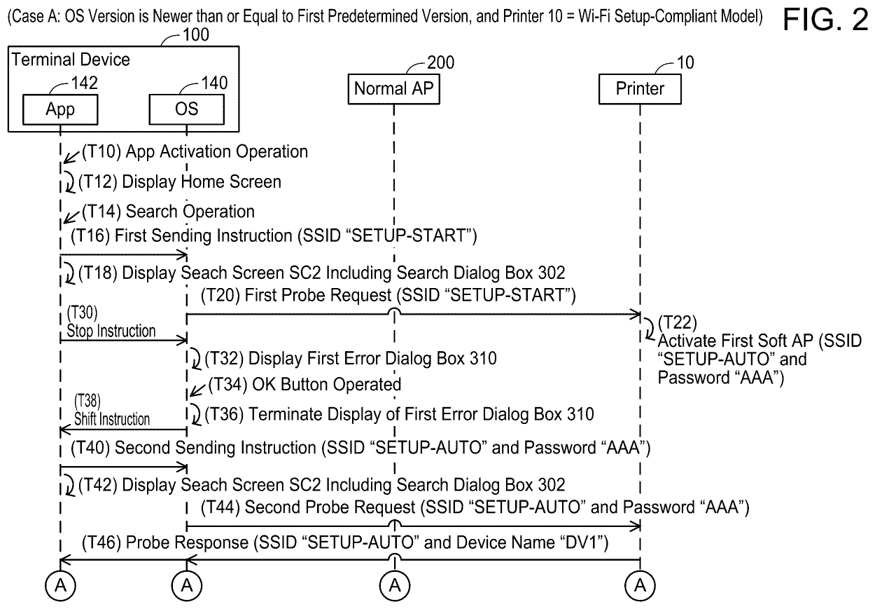

Referring to FIGS. 2 to 7, specific cases which can be realized by the communication system 2 according to this embodiment are described.

### Case A: FIGS. 2 to 4

Referring to FIGS. 2 to 4, Case A is described. In Case A, a normal AP connection is established between the printer 10 and the normal AP 200. In Case A, the version of the OS 140 is a first predetermined version or newer, and the printer 10 is of the Wi-Fi setup-compliant model. Hereinafter, all communications between the printer 10 and the terminal device 100 are executed via the wireless I/F 20 of the printer 10 and the wireless I/F 120 of the terminal device 100, and thus a phrase “via the wireless I/F 20, 120” is omitted in the following description. Further, the app 142 accesses the hardware, such as the display unit 114, the memory 134, the wireless I/F 120, etc., via the OS 140 to execute various processes. The app 142 executing the processes via the OS 140 may be omitted in the following description. Further, in the drawings, screens and dialog boxes that the app 142 causes the OS 140 to display are shown by thin lines, while screens and dialog boxes that the OS 140 displays are shown in bold lines. Further, “provide an instruction/information to the OS 140/the app 142” in the following description can be said to mean “provide an instruction/information to the CPU 132 (computer) operating according to the OS 140/the app 142”.

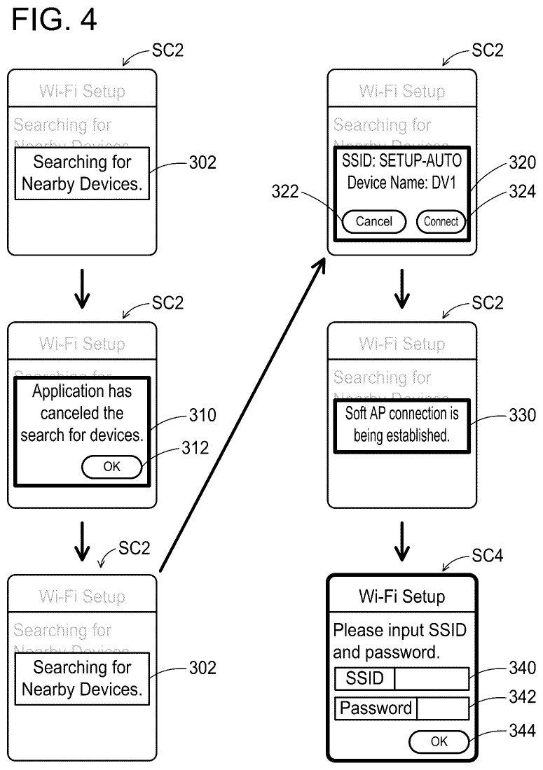

In T10, the user performs an app activation operation for activating the app 142 at the terminal device 100. In response, the app 142 displays a home screen on the display unit 114 in T12. The home screen includes a search button for causing the terminal device 100 to search for a device with which a normal AP connection is to be established, etc. The search button also serves as a button for activating a SoftAP of a printer of the Wi-Fi setup-compliant model. Once activated, the app 142 operates in either an uncontrolled state in which operations (control) based on the app 142 are not limited or a controlled state in which operations based on the app 142 are limited. In the state in which operations based on the app 142 are limited, the OS 140 does not execute operations according to information and instructions provided from the app 142. Once activated, the app 142 starts operating in the controlled state. In T14, the user performs a search operation of selecting the search button in the home screen at the terminal device 100. In response, the app 142 determines that the operation on the search button has been received and specifies the setup start information 144 (i.e., SSID “SETUP-START”) in the memory 134. Then, the app 142 provides a first sending instruction including the specified SSID “SETUP-START” to the OS 140. The first sending instruction is a signal for causing the OS 140 to send a first Probe request including the SSID “SETUP-START”. The app 142 then displays a search screen SC2 including a search dialog box 302 on the display unit 114 in T18. As shown in FIG. 4, the search screen SC2 and the search dialog box 302 each include a message indicating that a search for a device present near the terminal device 100 is in progress.

In response to acquiring the first sending instruction from the app 142 in T16 of FIG. 2, the OS 140 sends a first Probe request including the SSID “SETUP-START” by broadcasting in T20. The OS 140 repeatedly sends the first Probe request until it receives a probe response to the first Probe request.

In response to receiving the first Probe request from the terminal device 100 in T20, the printer 10 determines that this request includes the SSID “SETUP-START”. The printer 10 then activates a first SoftAP by using the first SoftAP information 42 in the memory 34 in T22. As a result, the operation state of the printer 10 shifts from a state in which the printer 10 does not belong to the first SoftAP NW to a parent station state in which the printer 10 operates as the parent station of the first SoftAP NW. Thus, the first Probe request including the SSID “SETUP-START” functions as a signal for causing the printer to operate as the parent station of the first SoftAP NW. Further, the printer 10 does not send a Probe response to the first Probe request since it has not activated a SoftAP using the SSID “SETUP-START”.

After a first predetermined time period (e.g., three seconds) has elapsed from when the first sending instruction was provided to the OS 140, the app 142 provides a stop instruction to the OS 140 in T30. The stop instruction is a signal for causing the OS 140 to stop sending the first Probe request.

In response to acquiring the stop instruction from the app 142 in T30, the OS 140 stops sending the first Probe request. The OS 140 then displays a first error dialog box 310 over the search screen SC2 in T32. As shown in FIG. 4, the first error dialog box 310 includes a message indicating that the app 142 has cancelled the search for a device and an OK button 312. In response to the OS 140 displaying the first error dialog box 310, the app 142 shifts from the controlled state to the uncontrolled state. In T34 of FIG. 2, the user performs an operation on the OK button 312 in the first error dialog box 310. In response, the OS 140 terminates the display of the first error dialog box 310 in T36 and provides a shift instruction to the app 142 in T38. The shift instruction is a signal for causing the app 142 to shift from the uncontrolled state to the controlled state.

In response to receiving the shift instruction from the OS 140 in T38, the app 142 shifts from the uncontrolled state to the controlled state and resumes its operation. The app 142 specifies the Third Soft AP information 146 (i.e., SSID “SETUP-AUTO”, password “AAA”) in the memory 134. The app 142 then provides a second sending instruction including the specified SSID “SETUP-AUTO” and password “AAA” to the OS 140 in T40. The second sending instruction is a signal for causing the OS140 to send a second Probe request including the specified SSID “SETUP-AUTO” and password “AAA”. T42 is the same as T18.

In response to acquiring the second sending instruction from the app 142 in T40, the OS 140 sends a second Probe request including the specified SSID “SETUP-AUTO” and password “AAA” by broadcasting in T44.

In response to receiving the second Probe request from the terminal device 100 in T44, the printer 10 sends a Probe response including the SSID “SETUP-AUTO” and the device name “DV1” to the terminal device 100 in T46 since the first SoftAP using the SSID “SETUP-AUTO” and the password “AAA” is running.

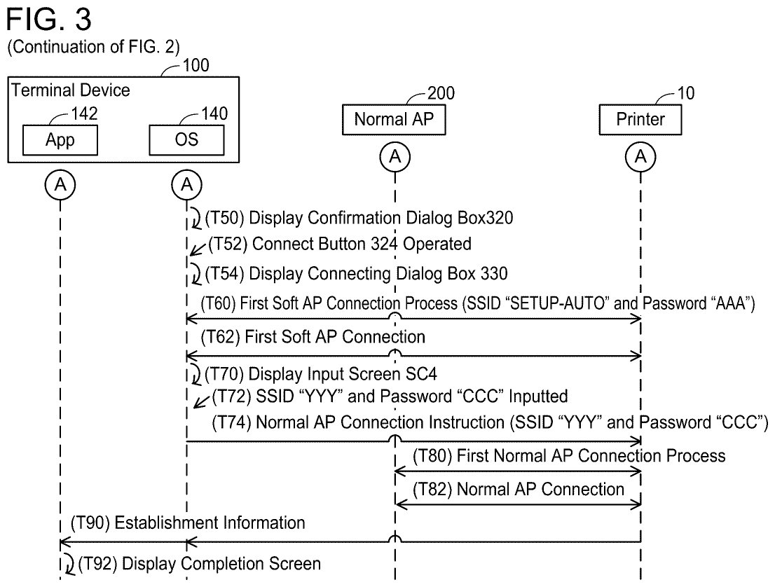

In response to receiving the Probe response from the printer 10 in T46, the OS 140 displays a confirmation dialog box 320 over the search screen SC2 in T50 of FIG. 3. As shown in FIG. 4, the confirmation dialog box 320 includes the received SSID “SETUP-AUTO”, the received device name “DV1”, a cancel button 322, and a connect button 324. The confirmation dialog box 320 is a screen for confirming a printer with which a normal AP connection is to be established. In T52 of FIG. 3, the user performs an operation on the connect button 324 in the confirmation dialog box 320. In response, the OS 140 displays a connecting dialog box 330 over the search screen SC2 in T54 instead of the confirmation dialog box 320. As shown in FIG. 4, the connecting dialog box 330 includes a message that establishment of a SoftAP connection with the printer is now in progress. In T60 of FIG. 3, the OS 140 executes a first SoftAP connection process to establish a first SoftAP connection with the printer 10. Specifically, the OS 140 sends an Association request including the SSID “SETUP-AUTO” to the printer 10 and then receives an Association response including the SSID “SETUP-AUTO” from the printer 10. The OS 140 further communicates various signals (e.g., 4-way handshake) with the printer 10, thereby establishing a first SoftAP connection with the printer 10 in T62. Thus, the terminal device 100 joins the first SoftAP NW as a child station in which the printer 10 operates as the parent station.

In T70, the OS 140 displays an input screen SC4 on the display unit 114. As shown in FIG. 4, the input screen SC4 includes a first input object 340 for input of an SSID, a second input object 342 for input of a password, and an OK button 344. The input screen SC4 is for input of an SSID and a password that are used in a normal AP NW the printer 10 is to join as a child station. In T72 of FIG. 3, the user inputs the SSID “YYY” and the password “CCC” to the first input object 340 and the second input object 342, respectively, and performs an operation on the OK button 344. In response, the OS 140 sends a normal AP connection instruction including the inputted SSID “YYY” and password “CCC” to the printer 10 in T74.

In response to receiving the normal AP connection instruction from the terminal device 100 in T74, the printer 10 executes a first normal AP connection process in T80 using the SSID “YYY” and the password “CCC” included in the instruction. During the first normal AP connection process, the printer 10 communicates various signals with the normal AP 200. This communication of various signals includes sending a probe request including the SSID “YYY”, receiving a Probe response including the SSID “YYY”, sending an Association request including the SSID “YYY”, receiving an Association response including the SSID “YYY”, 4-way handshake, etc. As a result, a normal AP connection is established between the printer 10 and the normal AP 200 in T82. That is, the printer 10 joins as a child station the normal AP NW formed by the normal AP 200 operating as the parent station. Thus, the printer 10 can execute various communications with other devices via the normal AP 200. For example, the printer 10 can receive an image file representing an image from another device via the normal AP 200 and cause the print executing unit 16 to print the image. In T90, the printer 10 sends establishment information indicating that the normal AP connection has been established to the terminal device 100. The first SoftAP connection between the printer 10 and the terminal device 100 is disconnected before the normal AP connection is established between the printer 10 and the normal AP 200 or after the normal AP connection has been established.

The app 142 receives the establishment information via the OS 140 from the printer 10 in T90, and then displays in T92 a completion screen indicating that the normal AP connection has been established between the printer 10 and the normal AP 200 on the display unit 114. In a modification, T90 and T92 may be omitted.

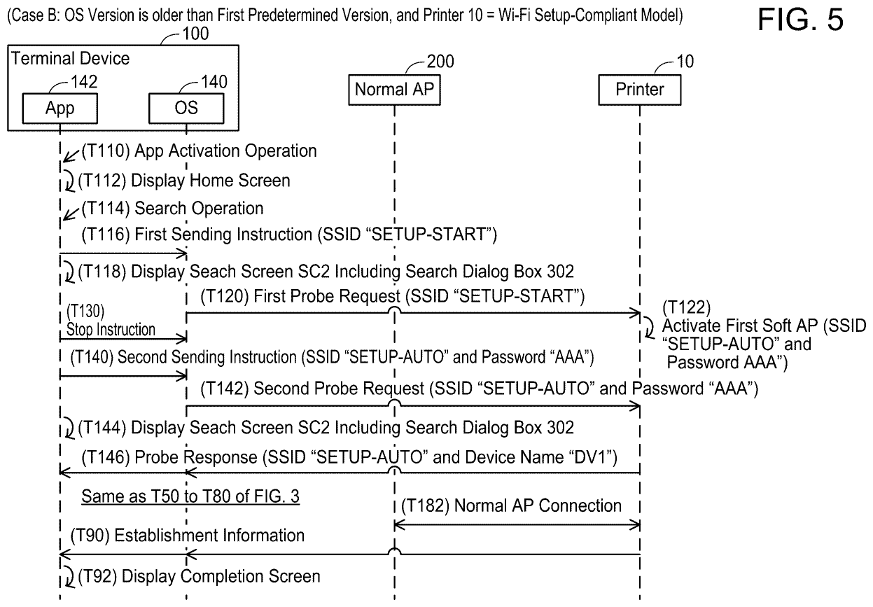

### Case B: FIG. 5

Referring to FIG. 5, Case B is described. In Case B, a normal AP connection is established between the printer 10 and the normal AP 200. In Case B, the version of the OS 140 is older than the first predetermined version, and the printer 10 is of the Wi-Fi setup-compliant model.

T110 to T130 are the same as T10 to T30 in FIG. 2. In the case where the version of the OS 140 is older than the first predetermined version, unlike the case where the version of the OS 140 is the first predetermined version or newer, the OS 140 does not display the first error dialog box 310 on the display unit 114 in response to acquiring the stop instruction from the app 142. Thus, the app 142 does not shift from the controlled state to the uncontrolled state after the stop instruction has been provided to the OS 140. In this case, the app 142 provides the second sending instruction to the OS 140 in T140 without receiving the shift instruction from the OS 140. T142, T144, T146 are same as T44, T42, T146 of FIG. 4, respectively. Thereafter, the same sequence as T50 to T80 in FIG. 3 is executed between the terminal device 100 and the normal AP 200. As a result, a normal AP connection is established between the printer 10 and the normal AP 200 in T182.

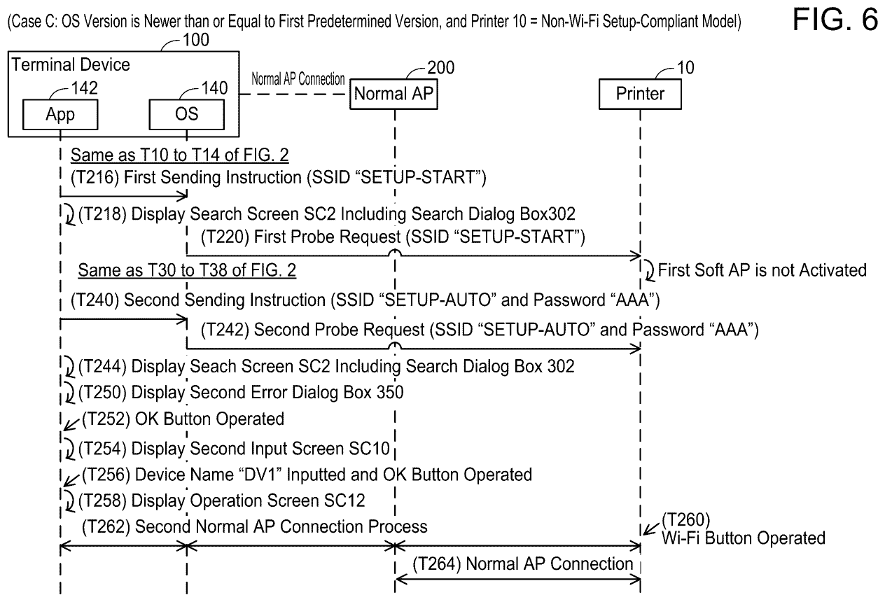

### Case C: FIG. 6

Referring to FIG. 6, Case C is described. In Case C, a normal AP connection is established between the printer 10 and the normal AP 200. In Case C, the version of the OS 140 is the first predetermined version or newer, and the printer 10 is of the non-Wi-Fi setup-compliant model. In the initial state of Case C, a normal AP connection is already established between the terminal device 100 and the normal AP 200. That is, the SSID “YYY” and the password “CCC” used in the normal AP NW are stored in the memory 134 of the terminal device 100.

First, the same sequence as T10 to T14 in FIG. 2 is executed. T216 to T220 are the same as T16 to T20 in FIG. 2. Since the printer 10 is of the non-Wi-Fi setup-compliant model, the printer 10 does not activate the first SoftAP in response to receiving the first Probe request from the terminal device 100.

Then, the same sequence as T30 to T38 in FIG. 2 is executed. T240, T242, T244 are the same as T40, T44, T42 in FIG. 2. Since the printer 10 does not activate the first SoftAP in the present case, the printer 10 does not send a Probe response in response to receiving the second Probe request from the terminal device 100.

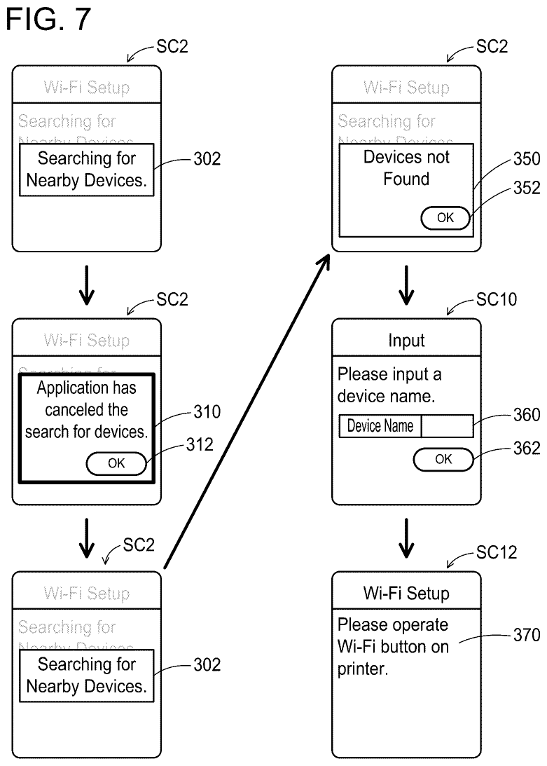

Since the app 142 does not receive a Probe response from the printer 10, the app 142 displays a second error dialog box 350 over the search screen SC2 in T250. As shown in FIG. 7, the second error dialog box 350 includes a message indicating that a device has not been found and an OK button 352. The user performs an operation on the OK button 352 in the second error dialog box 350 in T252 of FIG. 6. In response, the app 142 displays a second input screen SC10 on the display unit 114 in T254 of FIG. 6. As shown in FIG. 7, the second input screen SC10 includes a third input object 360 for input of a device name and an OK button 362. The second input screen SC10 is for input of the device name of a printer with which a normal AP connection is to be established. The user inputs the device name “DV1” and performs an operation on the OK button 362 in T256 of FIG. 6. In response, the app 142 displays an operation screen SC12 on the display unit 114 in T258. As shown in FIG. 7, the operation screen SC12 includes a message that prompts the user to perform an operation on the Wi-Fi button at the printer 10.

In T260 of FIG. 6, the user performs an operation on the Wi-Fi button of the operation unit 12 at the printer 10. In response, a second normal AP connection process is executed between the printer 10, the terminal device 100, and the normal AP in T262. The second normal AP connection process includes a SoftAP activation process, a first establishment process, an AP information communication process, and a second establishment process. In the SoftAP activation process, the printer 10 activates a second SoftAP. In the first establishment process, a second SoftAP connection is established between the terminal device 100 and the printer 10 operating as the second SoftAP. In the AP information communication process, the SSID “YYY” and the password “CCC” are sent from the terminal device 100 to the printer 10 through the second SoftAP connection. In the second establishment process, the printer 10 establishes a normal AP connection with the normal AP 200 using the received SSID “YYY” and password “CCC”. Thus, the normal AP connection is established between the printer 10 and the normal AP 200 in T264.

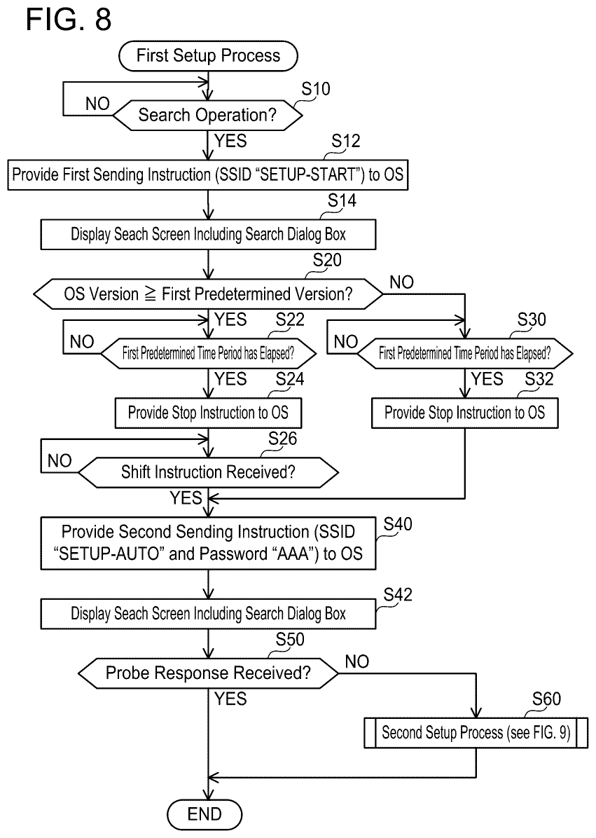

### First Setup Process: FIG. 8

Referring to FIG. 8, a first setup process executed by the app 142 in the terminal device 100 is described. The app 142 starts the process of FIG. 8 in response to being activated.

In S10, the app 142 monitors whether an operation is performed on the search button in the home screen. When an operation is performed on the search button, the app 142 makes a determination YES in S10 and proceeds to S12.

In S12, the app 142 provides the first sending instruction including the SSID “SETUP-START” to the OS 140 (T16 in FIG. 2, T116 in FIG. 5, T216 in FIG. 6).

In S14, the app 142 displays the search screen SC2 including the search dialog box 302 on the display unit 114 (T18 in FIG. 2, T118 in FIG. 5, T218 in FIG. 6).

In S20, the app 142 determines whether or not the version of the OS 140 is the first predetermined version or newer. When determining that the version of the OS 140 is the first predetermined version or newer (YES in S20), the app 142 proceeds to S22, whereas when determining that the version of the OS 140 is older than the first predetermined version (NO in S20), the app 142 proceeds to S30.

In S22, the app 142 monitors whether the first predetermined time period has elapsed from when the first sending instruction was provided to the OS 140. When determining that the first predetermined time period has elapsed, the app 142 makes a determination YES in S22 and proceeds to S24.

In S24, the app 142 provides the stop instruction to the OS 140 (T30 in FIG. 2). Thus, the app 142 causes the OS 140 to stop sending the first Probe request in response to the first predetermined time period having elapsed from when the first sending instruction was provided to the OS 140. The OS 140 automatically stops sending the first Probe request without acquiring the stop instruction from the app 142, in response to a second predetermined time period having elapsed from when the first sending instruction was acquired without a Probe response to the first Probe request being received. Here, the second predetermined time period is longer than the first predetermined time period. Thus, the above configuration can reduce the time from when the first sending instruction was provided to the OS 140 to when the first error dialog box 310 is displayed, compared to a configuration in which the app 142 does not provide the stop instruction to the OS 140. The above configuration can thus reduce the time required to establish a SoftAP connection between the terminal device 100 and the printer 10.

In S26, the app 142 monitors whether the shift instruction is received from the OS 140. When the shift instruction is received from the OS 140 (T38 in FIG. 2), the app 142 makes a determination YES in S26 and proceeds to S40.

S30 and S32 are the same as S22 and S24, respectively. After S32, the app 142 proceeds to S40 without monitoring whether the shift instruction is received from the OS 140. Thus, the app 142 determines whether to execute S26 or not depending on the version of the OS 140. Regardless of whether the version of the OS 140 is the first predetermined version or newer, or older than the first predetermined version, a SoftAP connection is established between the terminal device 100 and the printer 10.

In S40, the app 142 provides the second sending instruction including the SSID “SETUP-AUTO” and the password “AAA” to the OS 140 (T40 in FIG. 2, T140 in FIG. 5, T240 in FIG. 6). S42 is the same as S14. As described, the information included in the first Probe request is different from the information included in the second Probe request. Specifically, the SSID included the first Probe request is different from the SSID included in the second Probe request. Thus, the printer 10 can appropriately execute processes corresponding to the SSIDs included in the respective Probe requests.

In S50, the app 142 determines whether a Probe response has been received from the printer 10. When determining that a Probe response has been received from the printer 10 (YES in S50) (T46 in FIG. 2, T146 in FIG. 5), the app 142 terminates the process of FIG. 8. After this, the sequence from T50 to T80 in FIG. 3 is executed between the printer 10, the terminal device 100, and the normal AP 200, as a result of which a normal AP connection is established between the printer 10 and the normal AP 200 (T82 in FIG. 3, T182 in FIG. 5). Conversely, when determining that a Probe response has not been received from the printer 10 (NO in S50), the app 142 proceeds to S60. The determination NO in S50 means that the printer 10 is of the non-Wi-Fi setup-compliant model (Case C shown in FIG. 6).

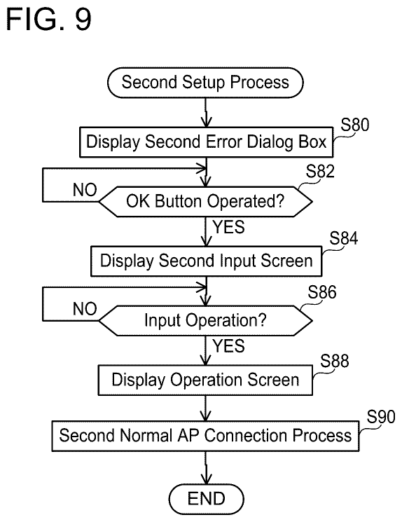

In S60, the app 142 executes a second setup process (see FIG. 9). In the second setup process, a normal AP connection is established between the printer 10 of the non-Wi-Fi setup-compliant model and the normal AP 200. After S60, the app 142 terminates the process of FIG. 8.

### Second Setup Process: FIG. 9

Referring to FIG. 9, the second setup process executed in S60 of FIG. 8 is described.

In S80, the app 142 displays the second error dialog box 350 over the search screen SC2 (T250 in FIG. 6).

In S82, the app 142 monitors whether an operation is performed on the OK button 352 in the second error dialog box 350. When an operation is performed on the OK button 352 (T252 in FIG. 6), the app 142 makes a determination YES in S82 and proceeds to S84.

In S84, the app 142 displays the second input screen SC10 on the display unit 114 (T254 in FIG. 6).

In S86, the app 142 monitors whether a device name is inputted. When receiving input of a device name (T256 in FIG. 6), the app 142 makes a determination YES in S86 and proceeds to S88.

In S88, the app 142 displays the operation screen SC12 on the display unit 114 (T258 in FIG. 6).

In S90, the app 142 executes the second normal AP connection process (T262 in FIG. 6). As a result, a normal AP connection is established between the printer 10 and the normal AP 200 (T264 in FIG. 6). After S90, the app 142 terminates the process of FIG. 9.

### Advantageous Effects of Present Embodiment

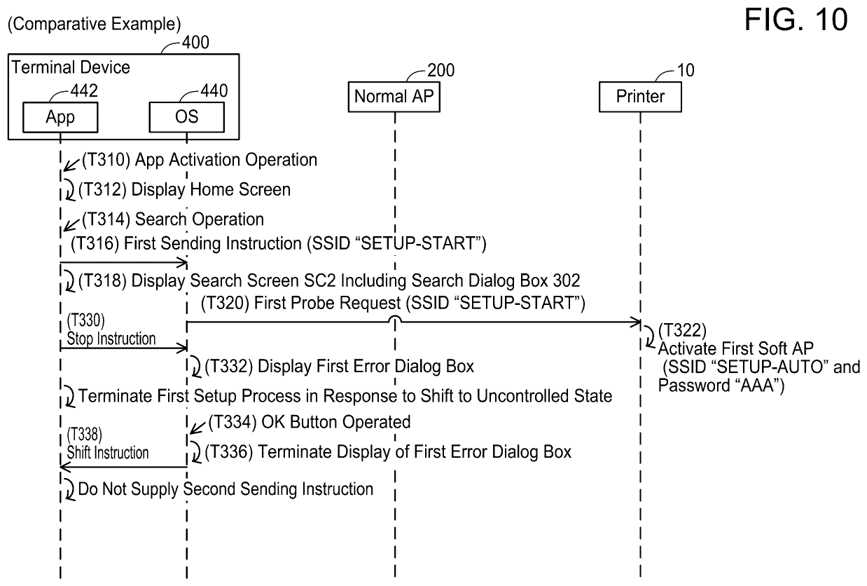

Before describing advantageous effects of the present embodiment, a process executed by a terminal device 400 according to a comparative example is described referring to FIG. 10. As shown in FIG. 10, an OS 440 and an app 442 are stored in a memory of the terminal device 400. The version of the OS 440 is the first predetermined version or newer. The app 442 is different from the app 142 in the terminal device 100 in that the former does not execute S20 to S24 in the first setup process of FIGS. 8.

T310 to T330 in FIG. 10 are the same as T10 to T30 in FIG. 2 except that the communication counterpart is the terminal device 400. In response to receiving the stop instruction from the app 442 in T330, the OS 440 displays the first error dialog box 310 over the search screen SC2 in T332. Further, in response to the first error dialog box 310 being displayed, the app 442 shifts from the controlled state to the uncontrolled state. Since the first setup process does not include monitoring whether the shift instruction is received from the OS 440 (S26 in FIG. 8), the app 442 terminates the first setup process in response to shifting to the uncontrolled state. T334 to T338 are the same as T34 to T38 in FIG. 2. Since the app 442 terminated the first setup process as described, the app 442 does not provide the second sending instruction to the OS 440 even when receiving the shift instruction from the OS 440 in T338. Thus, T42 to T46 in FIGS. 2 and T50 to T82 in FIG. 3 are not executed. That is, a first SoftAP connection is not established between the printer 10 and the terminal device 400. Thus, a normal AP connection is not established between the printer 10 and the normal AP 200, either.

According to the configuration of the present embodiment, the app 142 provides the first sending instruction to the OS 140 (S12 in FIG. 8), and supplies the second sending instruction to the OS 140 (S40) in the case where the shift instruction is received from the OS 140 (YES in S24). As a result, a SoftAP connection is established between the printer 10 and the terminal device 100 using the SSID “SETUP-AUTO” and the password “AAA” included in the second sending instruction. Thus, a wireless connection can be established between the printer 10 and the terminal device 100.

Especially, in the embodiment, since the first setup process includes monitoring whether the shift instruction is received from the OS 440 (S26 in FIG. 8), the app 142 does not terminate the first setup process even when shifted to the uncontrolled state. Thus, the app 142 provides the second sending instruction to the OS 140 in response to receiving the shift instruction from the OS 140. Thus, T60 in FIG. 3 is executed, and a first SoftAP connection is thereby established between the printer 10 and the terminal device 100 (T62 in FIG. 3).

### Correspondence Relationships

The app 142 is an example of “computer-readable instructions for a terminal device”. The printer 10 is an example of “printing device”. The first SoftAP NW is an example of “wireless network”. The first Probe request in T20 of FIG. 2 is an example of “specific signal”. The first error dialog box 310 shown in FIG. 4 is an example of “error screen”. T34 of FIG. 2 is an example of “predetermined operation”. The shift instruction in T38 of FIG. 2 is an example of “related information”. The first SoftAP connection is an example of “wireless connection with the printing device”. The SSID “SETUP-AUTO” and the password “AAA” are an example of “first connection information”. The second Probe request in T44 of FIG. 2 is an example of “Probe request”. The version of the OS 140 being the first predetermined version or newer is an example of “within a predetermined version range”. The SSID “SETUP-START” is an example of “second connection information”. The SSID “SETUP-AUTO” is an example of “first SSID”. The SSID “SETUP-START” is an example of “second SSID”. The first predetermined time period is an example of “predetermined time period”.

T16 of FIGS. 2 and S12 of FIG. 8 are examples of “provide a first sending instruction to an operating system (OS) program of the terminal device”. T40 of FIG. 2 and S40 of FIG. 8 are examples of “provide a second sending instruction to the OS program”.

(Modification 1) The “printing device” is not limited to a printer, and may be a multifunctional device configured to execute a scanner function in addition to a print function, a copy machine, etc.

(Modification 2) The “related information” is not limited to shift instruction, and may be information indicating that the display of the first error dialog box 310 has terminated or information indicating that limitation on the operation of the app 142 has been lifted, or the like.

(Modification 3) In S20 of FIG. 8, the app 142 may determine whether the version of the OS is the first predetermined version or newer and older than a second predetermined version which is newer than the first predetermined version. In this modification, the version of the OS being older than the second predetermined version, which is newer than the first predetermined version, is an example of “within a predetermined version range”.

(Modification 4) S20, S30, and S32 in FIG. 8 may be omitted if all the versions of available OSes are either the first predetermined version or newer.

(Modification 5) The “specific signal” is not limited to a Probe request, and may be Service Discovery or the like. Generally speaking, the “specific signal” may be any signal as long as it triggers the printer 10 of the Wi-Fi setup-compliant model to activate the first SoftAP. In the case where the app 142 sends Service Discovery instead of the first Probe request, the Service Discovery may not include the SSID “SETUP-START”. In this modification, the “first connection information” may be omitted.

(Modification 6) The information included in the first Probe request may be identical to the information included in the second Probe request. That is, the first and second Probe requests may include the SSID “SETUP-AUTO” and the password “AAA”. In this modification, the OS 140 sends the first Probe request only once by broadcasting.

(Modification 7) S22 and S30 of FIG. 8 may be omitted. In this modification, in the case where a third predetermined time period has elapsed from when the OS 140 acquired the first sending instruction from the app 142 without a response to the first Probe request being received from the printer 10, the OS 140 stops sending the first Probe request and displays the first error dialog box 310 over the search screen SC2. The third predetermined time period is longer than the first predetermined time period. In this modification, the third predetermined time period is an example of “predetermined time period”. In this modification, “provide a stop instruction to the OS program” may be omitted.

(Modification 8) The app 142 is not limited to a resident app, and may be a non-resident app.

(Modification 9) In the embodiment above, the processes shown in FIGS. 2 to 9 are implemented by software (e.g., the programs 140, 142), however, at least one of these processes may be implemented by hardware such as a logic circuit.

What is claimed is:

1. A non-transitory computer-readable recording medium storing computer-readable instructions for a terminal device comprising a processor,
wherein the computer-readable instructions, when executed by the processor, cause the terminal device to:
provide a first sending instruction to an operating system (OS) program of the terminal device, the first sending instruction being for sending a specific signal to cause a printing device to operate as a parent station of a wireless network; and
in a case where related information is received, provide a second sending instruction to the OS program, the related information being provided according to the OS program in response to a predetermined operation for terminating display of an error screen being received, the error screen being displayed on a display of the terminal device according to the OS program in a case where a predetermined time period has elapsed without a response to the specific signal being received after the first sending instruction has been provided to the OS program, the second sending instruction being for sending a Probe request including first connection information for establishing a wireless connection with the printing device.

2. The non-transitory computer-readable recording medium according to claim 1, wherein in a case where a version of the OS program is within a predetermined version range, the error screen is displayed on the display according to the OS program, and
in a case where the version of the OS program is not within the predetermined version range, the error screen is not displayed,
wherein in a case where the version of the OS program is within the predetermined version range and the related information is received, the second sending instruction is provided to the OS program, and
in the case where the version of the OS program is not within the predetermined version range, the second sending instruction is provided to the OS program without the related information being received after the first sending instruction has been provided to the OS program.

3. The non-transitory computer-readable recording medium according to claim 1, wherein the first connection information includes information to join the wireless network as a child station.

4. The non-transitory computer-readable recording medium according to claim 1, wherein the specific signal is a Probe request including second connection information.

5. The non-transitory computer-readable recording medium according to claim 4, wherein the first connection information is different from the second connection information.

6. The non-transitory computer-readable recording medium according to claim 5, wherein the first connection information includes a first service set identifier (SSID), and
the second connection information includes a second SSID different from the first SSID.

7. The non-transitory computer-readable recording medium according to claim 1, wherein the specific signal is sent repeatedly according to the OS program, and
wherein the computer-readable instructions, when executed by the processor, further cause the terminal device to:
in a case where the predetermined time period has elapsed from when the first sending instruction was provided, provide a stop instruction to the OS program, wherein the stop instruction is for stopping sending of the specific signal,
wherein in a case where the stop instruction is provided to the OS program without a response to the specific signal being received from the printing device, the error screen is displayed on the display according to the OS program.

8. A terminal device comprising:
a display; and
a controller configured to:
provide a first sending instruction to an operating system (OS) program of the terminal device, the first sending instruction being for sending a specific signal to cause a printing device to operate as a parent station of a wireless network; and
in a case where related information is received, provide a second sending instruction to the OS program, the related information being provided according to the OS program in response to a predetermined operation for terminating display of an error screen being received, the error screen being displayed on a display of the terminal device according to the OS program in a case where a predetermined time period has elapsed without a response to the specific signal being received after the first sending instruction has been provided to the OS program, the second sending instruction being for sending a Probe request including first connection information for establishing a wireless connection with the printing device.

9. The terminal device according to claim 8, wherein in a case where a version of the OS program is within a predetermined version range, the error screen is displayed on the display according to the OS program, and
in a case where the version of the OS program is not within the predetermined version range, the error screen is not displayed,
wherein in a case where the version of the OS program is within the predetermined version range and the related information is received, the second sending instruction is provided to the OS program, and
in the case where the version of the OS program is not within the predetermined version range, the second sending instruction is provided to the OS program without the related information being received after the first sending instruction has been provided to the OS program.

10. The terminal device according to claim 8, wherein the first connection information includes information to join the wireless network as a child station.

11. The terminal device according to claim 8, wherein the specific signal is a Probe request including second connection information.

12. The terminal device according to claim 11, wherein the first connection information is different from the second connection information.

13. A method for controlling a terminal device, the method comprising:
providing a first sending instruction to an operating system (OS) program of the terminal device, wherein the first sending instruction is for sending a specific signal to cause a printing device to operate as a parent station of a wireless network; and
in a case where related information is received, providing a second sending instruction to the OS program, the related information is provided according to the OS program in response to a predetermined operation for terminating display of an error screen being received, the error screen being displayed on a display of the terminal device according to the OS program in a case where a predetermined time period has elapsed without a response to the specific signal being received after the first sending instruction has been provided to the OS program, the second sending instruction being for sending a Probe request including first connection information for establishing a wireless connection with the printing device.

14. The method according to claim 13, wherein in a case where a version of the OS program is within a predetermined version range, the error screen is displayed on the display according to the OS program, and
in a case where the version of the OS program is not within the predetermined version range, the error screen is not displayed,
wherein in a case where the version of the OS program is within the predetermined version range and the related information is received, the second sending instruction is provided to the OS program, and
in the case where the version of the OS program is not within the predetermined version range, the second sending instruction is provided to the OS program without the related information being received after the first sending instruction has been provided to the OS program.

15. The method according to claim 13, wherein the first connection information includes information to join the wireless network as a child station.

16. The method according to claim 13, wherein the specific signal is a Probe request including second connection information.

17. The method according to claim 16, wherein the first connection information is different from the second connection information.

18. The method according to claim 17, wherein the first connection information includes a first service set identifier (SSID), and
the second connection information includes a second SSID different from the first SSID.

19. The method according to claim 13, wherein the specific signal is sent repeatedly according to the OS program, and
wherein the method further comprises:
in a case where the predetermined time period has elapsed from when the first sending instruction was provided, providing a stop instruction to the OS program, wherein the stop instruction is for stopping sending of the specific signal,
wherein in a case where the stop instruction is provided to the OS program without a response to the specific signal being received from the printing device, the error screen is displayed on the display according to the OS program.
